(19) United States
(12) Patent Application Publication
(10) Pub. No.: US 2013/0254168 A1
(43) Pub. Date: Sep. 26, 2013

(54) Data Integrity Validation

(71) Applicant: Gregory Dale Leman, Durham, NC (US)

(72) Inventor: Gregory Dale Leman, Durham, NC (US)

(21) Appl. No.: 13/836,670

(22) Filed: Mar. 15, 2013

Related U.S. Application Data
(60) Provisional application No. 61/613,757, filed on Mar. 21, 2012.

(51) Int. Cl. G06F 17/30

(52) U.S. Cl. CPC G06F 17/30371
USPC 707/687

(57) ABSTRACT

Computer-implemented systems for searching within a database, providing searching and scoring exact and non-exact matches of data from a plurality of databases to validate data integrity. Embodiments are described relating to novel systems and methods for validating data. The embodiments create a “consensus value” for various items of data based on information shared by different entities, whose separate data can be used for this purpose whilst maintaining its confidentiality from other entities, who may be business competitors and/or who for various reasons should preferably not be given access to the data. Use of consensus value validation provides significant advantages over today's methodology of reliance on outside data vendors to provide purportedly fact-checked clean data.

### FIELD OF THE INVENTION

The present invention generally relates to computer-implemented systems for searching within a database. More specifically, the present invention relates to searching and scoring exact and non-exact matches of data from a plurality of databases to validate data integrity.

### BACKGROUND

It is widely understood that the quality of data in enterprises is highly variable. Even companies that spend millions of dollars attempting to keep their data clean, accurate, and up-to-date often fail badly.

The current approach with respect to certain types of data, for example, customer data, is for companies to validate their internal data by purchasing data from external data source vendors. These vendors provide data that they claim to have verified. Typical methods of verification are labor intensive—for example, telephone numbers verified by placing calls to the number, email addresses verified by click-back responses, and so forth. Enterprises pay these vendors millions of dollars a year in license fees in order to be able to compare their own data to such an external source and, based on that comparison, attempt to determine the validity or falsity of their own data. This method is not only extremely expensive, but it is also a fairly limited check since there are relatively few external data vendors and the vendors' methodology of requiring verified sources means that the data is seldom up-to-date. Yet at present, a single vendor of such services reportedly earns over a billion dollars in revenues from supplying fact-checked customer data to companies.

### BRIEF DESCRIPTION

Embodiments are described relating to novel systems and methods for validating data. The embodiments create a “consensus value” for various items of data based on information shared by different entities, whose separate data can be used for this purpose whilst maintaining its confidentiality from other entities, who may be business competitors and/or who for various reasons should preferably not be given access to the data. Use of consensus value validation provides significant advantages over today's methodology of reliance on outside data vendors to provide purportedly fact-checked clean data.

### BRIEF DESCRIPTION OF THE DRAWINGS

FIG. 1 is a diagram of an example of a network in which systems and methods described herein may be implemented.

FIG. 2 is a flowchart of an embodiment of the subject invention.

FIG. 3 is a diagram showing data elements within an example central database in which the systems and methods described herein may be implemented.

FIG. 4 is a diagram showing the assignment of consensus values to the data elements in the central database of FIG. 3, according to the systems and methods described herein.

### DETAILED DESCRIPTION

An exemplary embodiment of the invention is hereafter described with reference to the drawings, but such description and drawings do not limit the scope of the invention. For example, the exemplary embodiment describes a system for validating customer data. Other embodiments may validate social media linkages, product part numbers and descriptions, geographic place names, workplace titles, alternate names for companies, patients' medical data, or any other type of data which may be stored in a database and for which validation is desired. Additionally, the exemplary embodiment is described in terms of a relational database, but the invention may be used in connection with a non-relational database as well.

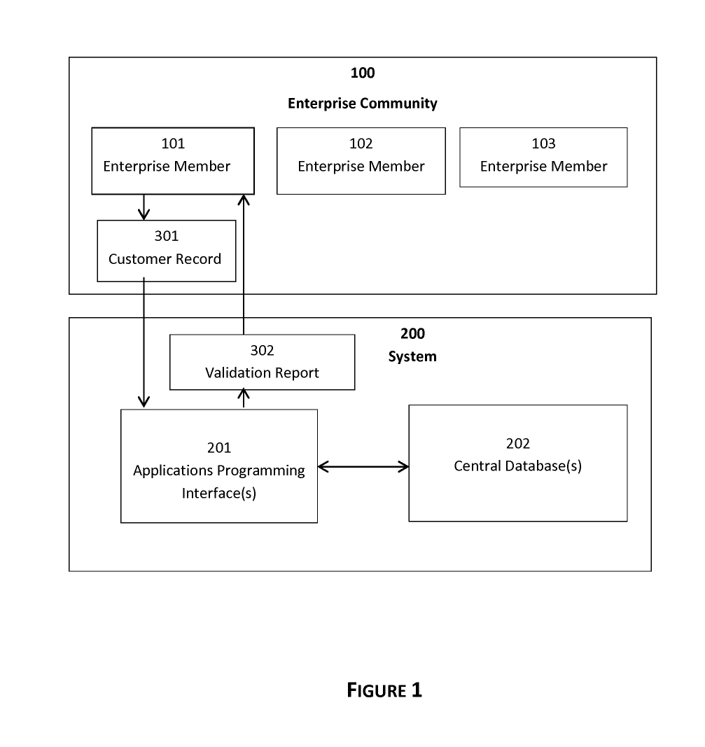

The exemplary embodiment utilizes a community of users referred to hereafter as the “Enterprise Community,” depicted in schematic form in FIG. 1 as Enterprise Community 100. Such a community of users need not be formally associated, of course, and no relationship amongst the users beyond common usage of the embodiment is required by the terms “enterprise,” “community,” and “member.” The Enterprise Community 100 preferably is comprised of at least three enterprises, shown schematically in FIG. 1 as Enterprise Members 101, 102, 103. Each Enterprise Member 101, 102, 103 possesses or otherwise controls a database of customer data, which typically is data concerning its own customers but could be data concerning the customers of one or more other enterprises. The data typically will comprise personally identifying information such as customer names, customer addresses, customer telephone numbers, customer email addresses, and other information concerning customers. The data pertaining to each customer preferably also will comprise an internal identifier, such as an alphanumeric string, that is uniquely associated with that customer in the member's database and is hereafter referred to as a Customer ID.

The exemplary embodiment further utilizes a system 200 comprising a central database 202 and an Applications Programming Interface (API) 201. Preferably, the contents of the central database 202 are stored in a location separate from the computers of Enterprise Members 101, 102, 103 and kept highly secure even from members of the Enterprise Community 100, so that there need be no concern about competitor access to private customer lists. In the exemplary embodiment, the central database 202 may be maintained on one or more computers. Other embodiments (not shown but more fully described below) may not require a central database 202.

In inventive embodiments not comprising a central database 202, the system 200 may comprise merely an API 201. The API 201 would comprise an aggregation process to create a list of dependencies and counts. The counts and encoded values would be provided to each Enterprise Member 101, 102, 103, which could then perform their own matching against the aggregate dependencies and counts. The encoded values provided may be non-invertible, providing the Enterprise Members 101, 102, 103 access to the encoded values but no information beyond their own records.

In certain embodiments, which may or may not comprise a central database 202, the system 200 may encode the original data entered by Enterprise Members 101, 102, 103 and discard the original data entries. This additional step provides increased security even beyond the concern about competitor access since the owner of the central database 202 would not have access to the original data.

As described in more detail hereafter and shown in overview form in FIG. 1, an Enterprise Member 101 submits to the system 200 a set of data entries for a specific customer, referred to hereafter as Customer Record 301. The API 201 receives the Customer Record 301, determines whether to accept the Customer Record 301 for processing, and evaluates whether the newly submitted data contained in the fields of Customer Record 301 match or deviate from previously submitted data in the same fields and having the same functional dependencies. For example, if there is a functional dependency between customer surname and email address, then two Customer Records 301, each having an email address field containing “j@x.com,” would be considered a match with respect to email address if each of those Customer Records 301 also had a customer surname field containing “SMITH,” but would not be considered a match if one had a customer surname field containing “SMITH” and the other had a customer surname field containing “JONES.” Of course, those skilled in the art will readily appreciate that it is not necessary to submit each record in a separate transmission as a single file; the API can be programmed to process records in whatever form they are received, whether sent one by one or included in a single large file transmission or in a database.

Pertinent items of data are associated with a consensus value that reflects the presence or absence of such matches and the frequency of matches and/or dissonances. The raw data comprising the consensus value in this embodiment is determined by a counting function that is incremented when validated matches are present and may be decremented when dissonant data is detected. The Enterprise Member 101 ultimately receives a Validation Report 302 that identifies whether Customer Record 301 has been seen before, in whole or in part, and the consensus value(s) assigned to Customer Record 301 as a whole and/or as to pertinent data elements. After processing and evaluation has been completed, those data elements comprising Customer Record 301 that are new to the system, optionally together with coding added to those elements by the API 201, are added to the central database 202. In an iterative process as more and more data is submitted, individual items of customer data as well as entire records relating to particular customers will, through use of the API 201, develop consensus values. The higher the consensus value, the more assured an enterprise may be of the data's trustworthiness.

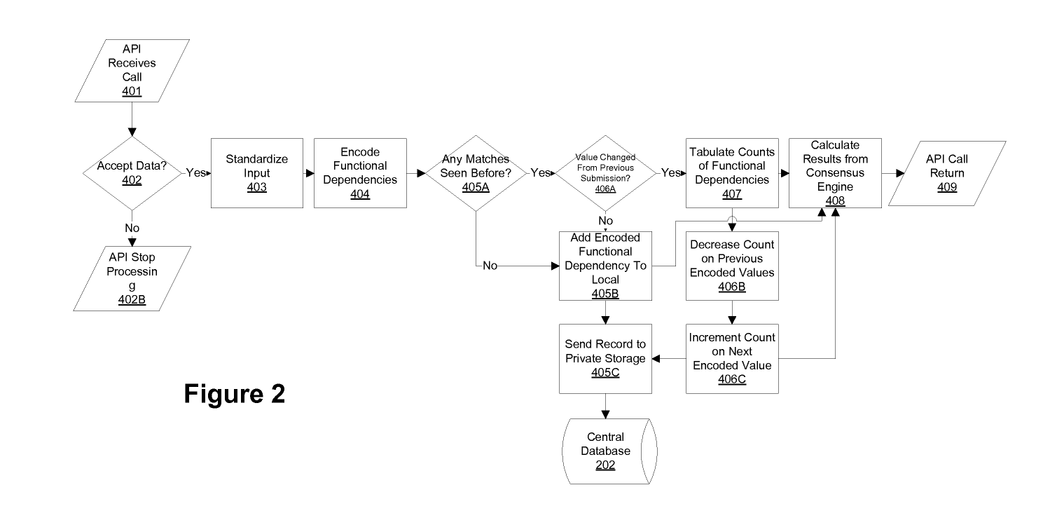

The example embodiment shown in FIG. 2 depicts processing steps taken by the API 201 of FIG. 1, to receive and process customer records. For purposes of this example, it is assumed that the central database 202 already contains records concerning two different customers that previously were submitted by one or more members of the Enterprise Community 100 of FIG. 1.

At Step 401, the API receives a call from Enterprise Member 101, transmitting the Customer Record 301. At Step 402, which is optional, the API determines whether to accept the Customer Record 301 for processing, by screening and identifying the submission. First, the API verifies the identity of the Enterprise Member that is submitting the record. To avoid the potential for a hacker to corrupt the database, records preferably are accepted only from Enterprise Members whose identity can be verified. In addition, preferably as part of this screening and identification procedure, the API may verify whether the Enterprise Member has assigned to the record a Customer ID. If the record is not from a verified source or does not contain a required data element such as a Customer ID, then at Step 402B, the API stops processing the record and optionally may notify the submitter that processing has been stopped and why.

At Step 403, after verifying and accepting the data, the API standardizes the data from Customer Record 301. This standardization includes identifying data corresponding to various pre-designated fields utilized by the central database and placing the data into the corresponding fields in the format designated for that field. For example, the API may identify a person's name as a name and an email address as an email address, and place the name into one or more “name” fields (for example, “surname” and “first name”) and the email address in an “email address” field.

At Step 404 the API encodes functional dependencies within the data. That is, certain attributes associated with customers are presumed to be uniquely associated with one or more other attributes; and codes identifying these relationships are associated with the appropriate data elements. A functional dependency can be described as follows:
An attribute is functionally dependent if its value is determined by another attribute. That is, if the value of one (or several) data elements is known, then the value of another (or several) data elements can be determined from those known values. Functional dependencies are expressed as A→B, where A is the determinant and B is the functionally dependent attribute.
If A→(B,C) then A→B and A→C.
If (A,B)→C, then it is not necessarily true that A→C and B→C.
If A→B and B→A, then A and B are in a 1-1 relationship.
If A→B then for A there can only ever be one value for B.

In the context of customer data being manipulated by the inventive systems and methods, a functional dependency might be defined between a person's name and that person's email address as described above, whilst a functional dependency might not be defined between a person's email address and that person's residence address. The invariants that link functionally dependent data typically will be chosen to reflect the likelihood that the two (or more) data fields are, in fact, interdependent in some way and that through a series of such linkages, one can determine whether or not the data contained in the fields is associated with a particular person. Often, an email address is used by a single individual having a particular surname. Thus, defining a functional dependency between the email address and surname is likely to be useful. On the other hand, many people have the same zip code, and many people have the same first name; defining a functional dependency between zip code and first name fields may be less useful. When those two fields are further considered together with telephone number, the number of persons who would have the same zip code, same first name, and same telephone number is substantially reduced and thus a functional dependency might be created among those three fields. Of course, any type of data may be manipulated in similar ways to identify functional dependencies.

Typically, the functional dependencies between various fields are predefined and, once the data has been sorted into standardized fields, the API may add appropriate coding to each data element that indicates the predefined functional dependencies. Adding coding in this manner speeds sorting of the data although it would be possible, for sufficiently small datasets or if processing power or time were not critical limitations, to sort the data using matrices or tables by maintaining appropriate field relationships during subsequent manipulation of the data. It is worth noting that the Customer ID assigned by a particular member will uniquely identify—for that member—one particular customer; and from the perspective of that member, there is a functional dependency between their Customer ID and the data elements associated with that customer. However, the Customer ID of one Enterprise Member will not necessarily, or even usually, be the same as that of another member.

At Step 405A, the API evaluates whether there are any matches within the database for customer data having the various functional dependencies assigned to the new data. For example, if customer surname and customer email address have a functional dependency, the database will be queried for data sharing the same customer surname and email address. The number and type of functional dependencies that are encoded at Step 404 and/or evaluated at Step 405A may vary according to the practitioner of the inventive method. Whether a “match” exists will be determined using standard database techniques well known to persons of ordinary skill in the field.

If the evaluation using the standard functional dependencies produces no matches, then optionally at Step 405B, the Enterprise Member may be given the opportunity to manually add functional dependencies to the submitted data. For example, even though many people would not find it effective to associate zip code and first name, the Enterprise Member may know that within its unique customer list, such associations are likely to generate useful matches and may, therefore, create a functional dependency between the customer first name and customer zip code fields. Of course, it is not necessary to stop processing the data whilst the Enterprise Member is asked whether to create such additional functional dependencies. The Enterprise Member may optionally pre-designate additional functional dependencies to evaluate either as a matter of standard procedure for all of its data, or for only those subsets of data that do not otherwise produce matches. The data may then be cycled through Step 405A again, i.e. compared with the database again to see if the new dependencies allowed any matches to be discovered. The data also may be cycled through Step 408 (described below).

After all desired functional dependencies have been added and all searches for matches have been performed, if the API cannot find match(es) sufficient to associate the submitted customer record with a previously-submitted customer record, then at Step 405C the data comprising the submitted customer record is sent to the central database 202 as a new entry, and stored in the database. As will be appreciated by those skilled in the art, at (or before) the time the customer record is stored in the central database, the customer record is assigned an identifier that is unique on a system-wide basis (rather than unique only to the Enterprise Member that submitted the record).

If, however, the API finds a match at Step 405A between the newly submitted record and a customer record that previously has been submitted, it associates the newly submitted record with the prior record and then at Step 406A evaluates whether the content of any of the data fields in the newly submitted customer record differs from the data associated with the same field in the prior customer record. If the newly submitted customer record matches in all respects the previously submitted customer record, (i.e., the same Enterprise Member has submitted, under its own Customer ID, a customer record that matches in all respects a set of data previously submitted by that Enterprise Member under the same Customer ID), then the API may either update the date on the record to reflect the currency of the information or take no action affecting the consensus value assigned to the data elements contained in the customer record. The API then moves forward to Step 106. The customer record is treated in this manner because there is nothing to indicate that the Enterprise Member has in any way evaluated or otherwise enhanced the reliability of any of the data comprising the customer record since the last time it was submitted by that Enterprise Member.

If, however, comparison of the records shows that a newly submitted data element associated with a particular field differs from the previously submitted data element associated with the same field or if there was no prior data in that field (for example, if a new telephone number has been submitted), or if identical customer data is submitted by a different Enterprise Member (typically indicated by the different Customer ID assigned to the data), then the API does take action affecting the consensus values.

If the newly submitted data element represents a change in data previously submitted for the same customer (i.e., a record with the same Customer ID) by the same Enterprise Member, then at Step 4066, the API may decrement the count for the pre-existing data element. Although it would be feasible to decrement the count when discrepant data is submitted, it is preferable not to do so. When a prior submitter has changed data, it can be presumed that the change was made knowingly and for good cause. Where discrepant data from multiple sources has been input, there is less reason to believe that any one of the sources is more reliable than any other, and so there is no reason to downgrade the pre-existing data. Preferably, the API will use a simple counter function and, when decrementing, will decrement the value for the older data by 1 in light of the disagreement between the two data elements and the determination by the originator of the data that the first value no longer is correct. Optionally, an Enterprise Member may manually adjust the value of the decrement to reflect its confidence in the change it has made. Assuming that all Enterprise Members have relatively similar standards in assessing the reliability of their own data, such optional adjustments could assist in more rapidly reaching reliable consensus as to particular data elements. Alternatively, the API may evaluate the reliability of an Enterprise Member according to a variety of factors, such as how often other Members modify their data to match that Member, how often the Member has a high consensus value for its own data, the number of edits that a Member makes to their own data, and determinations by the system owner that a Member is especially reliable (e.g., a well-known data vendor may have more reliable information than a small unknown company).

The API also will assign, at Step 406C, a consensus value to each newly submitted data element(s). Preferably in the example of FIG. 2, each newly submitted data element will be assumed to be equally trustworthy and will be assigned a consensus value of 1. However, weighting methods could be employed. For example, where an Enterprise Member has initially submitted a value for a particular customer and then later submits a record for the same customer in which that value has been changed, as described in the preceding paragraph, the new data might be presumed to be extra reliable and assigned a higher consensus value. After processing, the record is, at Step 405C, sent to the central database 202 as an updated record, and stored in the database.

If the customer data entries have not changed or if one or more entries have changed and the consensus values already have been modified at Steps 406A through 406C, then at Step 407 the API records the counts of the functional dependencies. The final consensus values may take into account one or more of the number of times the same pairs appear regardless of the record with which they are associated; the number of times the same pairs appear in association with the system-wide identifier for this customer; the number of times the same pairs are associated with unique Customer IDs, thus indicating how many different Enterprise Members have the same information; and other statistical measures as appropriate.

At Step 408, the API then takes any additional steps necessary to validate the data. The API calculates a consensus value for the record as a whole, taking into consideration, as appropriate, one or more statistical measures, manual adjustments made by Enterprise Members, and/or the reliability of the Enterprise Members submitting data for the record. The API also calculates a consensus value for the data in each of the fields of the record, and/or the data in selected fields or functionally dependent fields considered to be of particular importance. The consensus value(s) in each case may be raw data in the form of counts and/or a calculated consensus value that rates the validity of the record and/or its constituent data elements compared to the values in the community database.

Finally, at Step 409, the API provides a report regarding the customer record to the Enterprise Member that submitted the record. Within the return information, the API may provide various consensus values for the customer record, including a consensus value for the record as a whole as well as consensus values for some or all fields of data, and/or for functionally dependent fields of data.

Optionally, the API may also provide a member-specific newsfeed, which would aggregate information regarding transactions that produce changes of consensus values, and inform the member that the new data has been submitted relating to that member's customers. As members review the changes and, in turn, update (or choose not to update) their own records in response to these newsfeeds, the community derived consensus values will quickly be propagated throughout the entire community and further updated where appropriate.

### Example Scenario 1

In this example scenario, Enterprise Member 101 submits the following record to the central database:
Company: TopHats for All, LLC
FirstName: John
Surname: Smith
Street Address: 123 Main Street
ZipCode: 27701
Phone: 999-555-1234
Email: tjs@j.com
   The record is determined to be new, so it is added to the central database as a new entry. Because there are no records against which to compare this record, no consensus value is added with respect to any of the data.

The next day, Enterprise Member 102 submits the following record to the central database:
Company: X-IT University
FirstName: Susie
Surname: Jones
Street Address: 245 1^{st} St.
ZipCode: 27514
Phone: 999-444-5678
Email: sj@x.edu
   Again, the record is determined to be new and is added to the central database as a new entry. Because no data element matches any other element, it is clear that there is no match between the two customers and no counts are added with respect to any of the data for their consensus values.

The following day, Enterprise Member 103 submits the following record:
CompanyName: [none]
FirstName: Susie
Surname: Jones
Street Address: 245 1^{st} St.
ZipCode: 27514
Phone: 999-444-5678
Email: sjo@c.com
   There is a match between five fields of the records relating to Susie Jones. Assuming the functional dependencies between these matches and customer identity are deemed sufficiently significant, the records will be considered a “match.” Once it has been determined that the two records both relate to the same customer, then the number of matching fields is counted, and each matching field is assigned a consensus value equal to the number of matches. Here, there are two matches for each of FirstName, Surname, StreetAddress, ZipCode, and Phone, but no matches for CompanyName or Email. A consensus value of 2 will be assigned to the FirstName, Surname, StreetAddress, ZipCode, and Phone for this customer, and no counts will be added to the consensus values for the customer's CompanyName and Email, which will remain at a count of one although each will be associated with the system record for customer Susie Jones.

On the fourth day, Enterprise Member 102 submits the following record:
Company: Best Pasta Sauces, Inc.
FirstName: John
Surname: Smith
Address: 123 Main Street
ZipCode: 27701
Phone: 919-444-4444
Email: js@y.com

At most, for John Smith, data for only four data fields (FirstName, Surname, Street, and ZipCode) can be found. If the API has been programmed to increment counts only when five fields match, or when a combination of FirstName, Surname, and at least 3 of the remaining fields match, then the API would not correlate the first record for “John Smith” with the second record for “John Smith” and none of the entries for “John Smith” would obtain counts greater than one at this point.

Incrementing the count for data elements associated with customer John Smith in this scenario will require obtaining data from at least a third customer record pertaining to John Smith. If, for example, Enterprise Member 103 thereafter submits a customer record matching that submitted by Enterprise Member 101, then the data submitted by Enterprise Member 101 and Enterprise Member 103 for Company, Phone, and Email would each have a consensus value of two; and the data entries submitted by each of the Enterprise Members for FirstName, Surname, StreetAddress, and ZipCode would each have a consensus value of three.

The API may assign enhanced significance to modifications made by an enterprise member to data that the same enterprise member previously submitted. Rather than simply treating the new data as an addition to the knowledge base, the alteration can be treated as reflecting negatively on the originally submitted data. For example, after the records described above in this Scenario had been submitted, Enterprise Member 102 might submit a revised record for its customer Susie Jones. (The fact that this is the same customer Susie Jones, and not a separate Susie Jones, would be determined by matching the CustomerID assigned by Enterprise Member 102 to this record, with the CustomerID assigned by Enterprise Member 102 to the previously submitted “Susie Jones” record.) The revised customer record might contain data matching in all respects (except Customer ID) the customer record for Susie Jones previously submitted by Enterprise Member 103. Notably, this would mean that the company name, telephone number, and email address for this customer now have been changed by Enterprise Member 102. Treating this as a vote of no confidence in Enterprise Member 102's earlier-submitted data for those fields, the counts for Enterprise Member 102's previous data entries for Company, Phone, and Email would each be decremented by one, leaving those data entries with a count of zero. The counts, and thus consensus values, assigned to the data in the remaining fields would be unchanged.

It should be noted that one-letter domains are not, under current rules, valid and thus none of the email addresses given above would actually be valid email addresses. However, the comparison would not detect this invalidity if in fact the various enterprises did submit records containing the invalid addresses as given in the foregoing example. Separate steps using external data sources to validate email addresses (or data in other fields) can be employed, if desired, to enhance the validity of the data. Such steps are well known to those of ordinary skill in the art.

A consensus value is derived from a rules driven engine that may be adjusted with respect to the weighting factors. Multiple consensus value algorithms may be supported, and each Enterprise Member may select the consensus scheme that makes the most sense for its business. For example, Enterprise Member 101 might adopt the weighting scheme described above wherein alterations in data submitted by a member decrement the consensus value for that data, while Enterprise Member 102 might not decrement the original data under those circumstances but might instead add an additional increment to the consensus value of the substituted data.

### Example Scenario 2

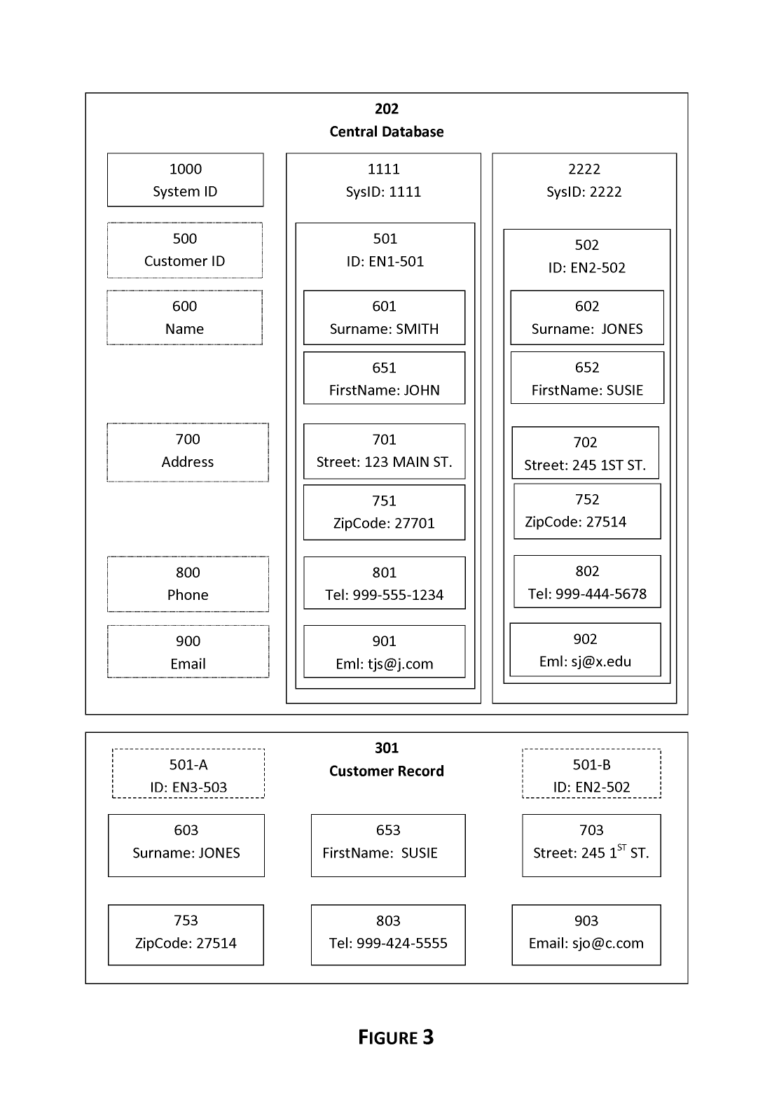

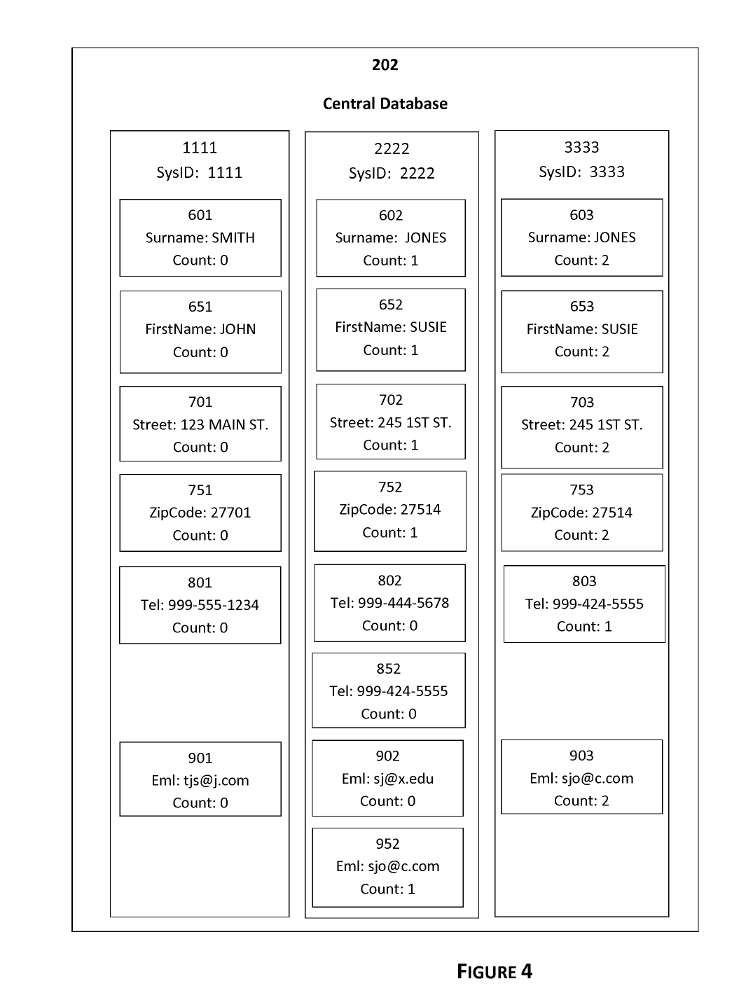

The following example is essentially a subset of the prior Scenario, described with reference to FIGS. 3 and 4.

FIG. 3 depicts central database 202 comprising two previously submitted customer records. System Record 1111, identified by a system-wide identifier SysID 1111, comprises customer record 501, which was submitted by Enterprise Member 101 and is identified by that member's Customer ID as EN1-501. System Record 2222, identified by a system-wide identifier SysID 2222, comprises customer record 502, which was submitted by Enterprise Member 102 and is identified by that member's Customer ID as EN2-502.

System Record 1111 comprises data elements in each of fields 501, 601, 651, 701, 751, 801, and 901. Those fields identify, respectively, the customer's surname, first name, street address, zip code, telephone number, and email address. System Record 2222 comprises data elements in each of fields 502, 602, 652, 702, 752, 802, and 902 which likewise identify, respectively, the customer's surname, first name, street address, zip code, telephone number, and email address.

Customer Record 301 comprises data elements for a third record, which has been processed by the API and determined to match System Record 2222. Customer Record 301 may emanate from Enterprise Member 103 and be identified with Customer ID EN3-503 or may, alternatively, emanate from Enterprise Member 102 and be identified with Customer ID EN2-502 (the same customer identification number assigned to a previously submitted record from Enterprise Member 102).

FIG. 4 depicts central database 202 comprising the two previously submitted customer records shown in the central database 202 of FIG. 3, together with the new data from Customer Record 301 of FIG. 3. For simplicity, the association between the data elements and their respective customer records is not shown; only the association between the data elements and their system-wide identifier is shown. Also for simplicity, where a data field was populated with identical data in each of two customer records, only one of the data elements is shown, but the database 202 will continue to maintain the duplicate records.

The customer data comprising System Record 1111 in FIG. 4 is unchanged from that depicted for System Record 1111 in FIG. 3. No new customer data has been added to System Record 1111, because Customer Record 301 did not match System Record 1111. The data comprising System Record 2222 in FIG. 4 reflects the same data in System Record 2222 as well as additional data elements 803 and 903. The API creates a new System Record 3333, which contains the information submitted in Customer Record 301. The API recognizes the differences in and currency of this new System Record 3333, and, based on these factors, the counts for the data elements of Record 3333 will be incremented and counts for Record 2222 will be decremented.

FIG. 4 shows not only the data elements present in System Records 1111 and 2222, but also the counts that have been calculated for the data. Because none of the data associated with System Record 1111 matches any other data in the central database 202, each element of data in System Record 1111 has a count of zero. On the other hand, the pre-existing data elements 602, 652, 702, 752 of System Record 2222 as shown in FIG. 3 were identical to data elements 603, 653, 703, and 753 of Customer Record 301. Thus, the counts associated with each of those data elements are incremented and those data elements each are assigned a count of 2 (indicating that two customer records for the same customer contained identical data in this field). The data elements associated with the telephone number and email address fields of the pre-existing System Record 2222 and the newly added Customer Record 301 did not match. Thus, those data elements have counts of zero: no matches have yet been found for data in those fields for this customer.

Optionally, the consensus value for the duplicated data would vary depending on whether the newly matching data emanated from Enterprise Member 103, identified with Customer ID EN3-503 or, alternatively, emanated from Enterprise Member 102, identified with Customer ID EN2-502 (the same customer identification number assigned to a previously submitted record from Enterprise Member 102). If the data emanated from Enterprise Member 103, then it would be treated as described above. However, if the data emanated from Enterprise Member 102, then the information previously submitted for the telephone number and email address might be considered discredited and those prior-submitted data elements might have their consensus values reduced by some amount, for instance by a value of 1. In the FIG. 4 example, that would result in the assignment of consensus values of −1 to each of data element 802 and 902. All other consensus values would be unchanged.

### Example Documentation

The following example provides an illustration of user documentation that could be provided to explain to an Enterprise Member how to submit records to an embodiment of the inventive system, and how to interpret the report that would be returned. The example assumes that the API utilizes a representational state transfer (REST) software architecture; that it can be queried using hypertext transfer protocol (HTTP) commands, and in particular HTTP GET requests; and that responses are provided in a language-independent data interchange format known as JavaScript Object Notation (JSON).

### API Commands

These endpoints are supported by the API:

### Name Description

valid_co Validate Company
map_co_alias Map Company Alias
valid_contact Validate Contact
valid_email Validate Email
map_title Map Title
valid_address Validate Address
valid_linkage Validate Linkage

### Common Parameters

apikey The personal API key that is issued to each member of the community. The apikey is used to track all of your interactions. You can see your apikey on this page when you are logged in.
cmd The command for this call. You'll see cmd values in each of the various commands available for the API.
cust_id You must specify a unique key for each unique organization or person that you validate. This might be a primary key from the database that holds your data, an identifier that you use, or merely generated. We use this key to track changes in your data and to notify you when the consensus values have changed on your data.
payload This isn't really a parameter. When you validate a record in our system you may also submit extra fields that you want us to track. For example, if you were validating records from several disparate systems in your organization you might want to add an identify named “system” that indicates the source of the record. To add a payload, just add a parameter that isn't one of our required parameters and we'll store it with your record.
callback Specify the name of a function and your return JSON will come wrapped as a json function.

### Validate Company

Company API Parameters

These are organizations consisting either of commercial enterprises, non-profits, or government entities.
apikey Your apikey
cmd valid_co
UserId This is the user assigned id for the record. You can assign any id that you desire (up to 256 characters), but it must be unique for this record. If you submit the same record in the future, it must have the same id.
Name The company name. This should be a fully spelled out legal name, not an alias. The company name will be standardized before it is encoded.
Url The URL of the home page for this company.
Address1 First line of the address. The address will be standardized before it is encoded.
Address2 Second line of the address.
City City for the address. The city will be standardized to a proper postal name before it is encoded.
State Abbreviate state code if applicable for this country.
PostalCode Postal Code.
Country Abbreviated country code.
Phone Main telephone number for the company. The number will be standardized before encoding. If no country code prefix present, the country field will be used to add it.
Fax Main fax number for the company. The number will be standardized before encoding. If no country code prefix present, the country field will be used to add it.
SIC Primary Standard Industry Classification code for this company. The number will be right zero padded to four digits before encoding.
NAICS Primary North American Industry Classification System code for this company. The number will be right zero padded to six digits before encoding.
Revenue Yearly revenue in USD for this company. This number is standardized into a range before encoding, so $125M and $130M in revenue will match.
Employees Number of employees for this company. This number is standardized into a range before encoding, so 50 employees will match 55.

### Example Call

https://api.consensics.com/?apikey=YOUR_APIKEY

&cmd=valid_co

&userid=example_userid

&name=example_name

&url=example_url

&address1=example_address1

&address2=example_address2

&city=example_city

&state=example_state

&postalcode=example_postalcode

&country=example_country

&phone=example_phone

&fax=example_fax

&sic=example_sic

&naics=example_naics

&revenue=example_revenue

&employees=example_employees

### Example Return

```
{
  “userid”:“example_userid”,
  “name”:“example_name”,
  “url”:“example_url”,
  “address1”:“example_address1”,
  “address2”:“example_address2”,
  “city”:“example_city”,
  “state”:“example_state”,
  “postalcode”:“example_postalcode”,
  “country”:“example_country”,
  “phone”:“example_phone”,
  “fax”:“example_fax”,
  “sic”:“example_sic”,
  “naics”:“example_naics”,
  “revenue”:“example_revenue”,
  “employees”:“example_employees”,
  “full_address_con”:100,
  “csp_con”:100,
  “phone_con”:100,
  “fax_con”:100,
  “phones_con”:100,
  “url_con”:100
}
```

### Company Aliases API Parameters

These are alias names for companies. This allows the comparison between names such as “International Business Machines” and “IBM”. We do not encode these values—we keep them in the database and aliases with extremely high consensus values are used in the normalization process.
UserId This is the user assigned id for the record. You can assign any id that you desire (up to 256 characters), but it must be unique for this record. If you submit the same record in the future, it must have the same id.
Name Legal name of the company, from the companies table.
Alternate An alternate name for the company.

### Example Call

https://api.consensics.com/?apikey=YOUR_APIKEY

&cmd=map_co_alias

&userid=example_userid

&name=example_name

&alternate=example_alternate

### Example Return

```
{
  “userid”:“example_userid”,
  “name”:“example_name”,
  “alternate”:“example_alternate”,
  “aliases_con”:100
}
```

### Validate Contact

Contacts API Parameters

These are individuals that are either standalone or are part of an organization.
apikey Your apikey
cmd valid_contact
UserId This is the user assigned id for the record. You can assign any id that you desire (up to 256 characters), but it must be unique for this record. If you submit the same record in the future, it must have the same id.
Name Full name of the individual.
Company The company name. This should be a fully spelled out legal name, not an alias. The company name will be standardized before it is encoded.
Title The title for the engineer, such as President or Engineer.
Email The email address.
Address1 First line of the address. The address will be standardized before it is encoded.
Address2 Second line of the address.
City City for the address. The city will be standardized to a proper postal name before it is encoded.
State Abbreviate state code if applicable for this country.
PostalCode Postal Code.
Country Abbreviated country code.
Phone Main telephone number for the contact. The number will be standardized before encoding. If no country code prefix present, the country field will be used to add it.
Fax Main fax number for the contact. The number will be standardized before encoding. If no country code prefix present, the country field will be used to add it.
Mobile Main mobile number for the contact. The number will be standardized before encoding. If no country code prefix present, the country field will be used to add it.

### Example Call

https://api.consensics.com/?apikey=YOUR_APIKEY

&cmd=valid_contact

&userid=example_userid

&name=example_name

&company=example_company

&title=example_title

&email=example_email

&address1=example_address1

&address2=example_address2

&city=example_city

&state=example_state

&postalcode=example_postalcode

&country=example_country

&phone=example_phone

&fax=example_fax

&mobile=example_mobile

### Example Return

```
{
  “userid”:“example_userid”,
  “name”:“example_name”,
  “company”:“example_company”,
  “title”:“example_title”,
  “email”:“example_email”,
  “address1”:“example_address1”,
  “address2”:“example_address2”,
  “city”:“example_city”,
  “state”:“example_state”,
  “postalcode”:“example_postalcode”,
  “country”:“example_country”,
  “phone”:“example_phone”,
  “fax”:“example_fax”,
  “mobile”:“example_mobile”,
  “full_con”:100,
  “name_company_con”:100,
  “name_title_con”:100,
  “name_email_con”:100,
  “name_co_title_email_con”:100,
  “email_cspc_con”:100,
  “email_phone_con”:100,
  “email_fax_con”:100,
  “email_mobile_con”:100,
  “email_address_con”:100
}
```

### Validate Email

Email API Parameters

These are email addresses. They're different from a contact in that all we know is a name and an email.
apikey Your apikey
cmd valid_email
UserId This is the user assigned id for the record. You can assign any id that you desire (up to 256 characters), but it must be unique for this record. If you submit the same record in the future, it must have the same id.
Name Full name of the individual.
Email The email address.

### Example Call

https://api.consensics.com/?apikey=YOUR_APIKEY

&cmd=valid_email

&userid=example_userid

&name=example_name

&email=example_email

### Example Return

```
{
  “userid”:“example_userid”,
  “name”:“example_name”,
  “email”:“example_email”,
  “name_email_con”:100,
  “only_email_con”:100,
  “deliverable_con”:100
}
```

### Map Title

Titles API Parameters

These are title mappings. This allows comparisons such as “Snr Engineer” and “Senior Engineer”. We do not encode these values. Title mappings with extremely high consensus values are used in the normalizations.
apikey Your apikey
cmd map_title
UserId This is the user assigned id for the record. You can assign any id that you desire (up to 256 characters), but it must be unique for this record. If you submit the same record in the future, it must have the same id.
Name The original title.
Alternate An alternate for the named title.

### Example Call

https://api.consensics.com/?apikey=YOUR_APIKEY

&cmd=map_title

&userid=example_userid

&name=example_name

&alternate=example_alternate

### Example Return

```
{
  “userid”:“example_userid”,
  “name”:“example_name”,
  “alternate”:“example_alternate”,
  “titles_con”:100
}
```

### Validate Address

Addresses API Parameters

These are plain addresses, not necessarily connected with a company or contact. We do not encode these values.
apikey Your apikey
cmd valid_address
UserId This is the user assigned id for the record. You can assign any id that you desire (up to 256 characters), but it must be unique for this record. If you submit the same record in the future, it must have the same id.
Address1 First line of the address.
Address2 Second line of the address.
City City for the address.
State Abbreviate state code if applicable for this country.
PostalCode Postal Code.
Country Abbreviated country code.

### Example Call

https://api.consensics.com/?apikey=YOUR_APIKEY

&cmd=valid_address

&userid=example_userid

&address1=example_address1

&address2=example_address2

&city=example_city

&state=example_state

&postalcode=example_postalcode

&country=example_country

### Example Return

```
{
  “userid”:“example_userid”,
  “address1”:“example_address1”,
  “address2”:“example_address2”,
  “city”:“example_city”,
  “state”:“example_state”,
  “postalcode”:“example_postalcode”,
  “country”:“example_country”,
  “full_con”:100,
  “add1_con”:100,
  “csp_con”:100
}
```

### Validate Linkage

Linkages API Parameters

These are linkages between identities indicating that two different identifiers are actually the same person.bobzilla1742@gmail.com could also be @BigDaddy2783 on Twitter.
apikey Your apikey
cmd valid_linkage
UserId This is the user assigned id for the record. You can assign any id that you desire (up to 256 characters), but it must be unique for this record. If you submit the same record in the future, it must have the same id.
FromSystem The first part of the linkage. For an email address, use \“email\”. For any other system, use the top level domain of the system such as \“twitter.com\”.
FromId The identifier on the from system. For an email, use the full email address. For other systems, use the identifier. For example, with a FromSystem=\“facebook.com\” the identifier could be a 15 digit numeric code.
ToSystem The second part of the linkage.
ToId The identifier on the to system.

### Example Call

https://api.consensics.com/?apikey=YOUR_APIKEY

&cmd=valid_linkage

&userid=example_userid

&fromsystem=example_fromsystem

&fromid=example_fromid

&tosystem=example_tosystem

&toid=example_toid

### Example Return

```
{
  “userid”:“example_userid”,
  “fromsystem”:“example_fromsystem”,
  “fromid”:“example_fromid”,
  “tosystem”:“example_tosystem”,
  “toid”:“example_toid”,
  “linkage_con”:100
}
```

The foregoing details are exemplary only. Other modifications that might be contemplated by those of ordinary skill in the art are within the scope of this invention, and the invention is not limited by the examples illustrated herein.

Without in any way limiting the scope of that which is claimed, and among other inventions, I claim:

1. A method for data integrity validation in an enterprise community having a plurality of enterprise members, each controlling customer records comprising data pertaining to customers, and having at least one data validation server comprising at least one non-transitory processor-readable medium, configured to maintain a set of identification data comprising at least two database customer records, each identifying a customer, each said database customer record comprising a plurality of data elements encoded with functional dependencies, each of said encoded data elements being further associated with a consensus value, the method comprising:
a. receiving from an enterprise member, at an application programming interface comprising at least one non-transitory processor-readable medium having stored thereon processor-executable code, an incoming customer record identifying a customer, comprising a plurality of data elements;
b. evaluating the authenticity of the incoming customer record and determining whether to accept it for processing;
c. accepting the incoming customer record and structuring the incoming customer record to associate the data elements of the incoming customer record with a plurality of predetermined fields, wherein a first data element of the incoming customer record is associated with a first predetermined field and a second data element of the incoming customer record is associated with a second predetermined field, and to standardize each of the data elements associated with a predetermined field in accordance with standards designated for the predetermined field;
d. encoding at least one of the data elements of the incoming customer record with one or more functional dependencies appropriate to the field associated with the element;
e. comparing the encoded data elements of the incoming customer record to the encoded data elements of the database customer record;
f. counting the matches between the encoded data elements of the incoming customer record and each of the database customer record;
g. evaluating, according to a predetermined weighting system based at least in part on the number of matches between the encoded data elements, whether the incoming customer record and a database customer record identify the same entity;
h. if the comparison does not determine that the incoming customer record identifies a customer identified in any of the at least two database customer record S, then
i. adding as a new record in the at least one data validation server the incoming customer record and
ii. associating a consensus value, according to a predetermined weighting system, with each encoded data element of the incoming customer record;
i. if the comparison determines that the incoming customer record and a database customer record identify the same entity, then
i. updating the consensus values associated with the encoded data elements of the “same entity” database customer record to reflect, according to a predetermined weighting system, the results of comparing the encoded data elements of the incoming customer record and the “same entity” database customer record; and
ii. associating at least one data element consensus value with the incoming customer record, each said data element consensus value comprising a value reflecting, according to a predetermined weighting system, the results of comparing the encoded data element of the incoming customer record and the encoded data element pertaining to the same field of the “same entity” database customer record;
j. storing the incoming customer record on the at least one data validation server;
k. providing a report, said report comprising at least one of:
i. the data consensus value for an encoded data element of the incoming customer record;
ii. a consensus value based at least in part upon the count of the matches between the encoded data elements of the incoming customer record and each of the database customer record S, and at least in part upon the data consensus value for an encoded data element of the incoming customer record; and
iii. a consensus value for the incoming customer record to reflect, according to a predetermined weighting system, the results of comparing a plurality of the encoded data elements contained in fields of the incoming customer record with the encoded data elements contained in counterpart fields of the “same entity” database customer record.

2. A system for data integrity validation, the system comprising:
at least one data validation server, comprising at least one non-transitory processor-readable medium, configured to maintain a set of identification data comprising at least two database identification records, each identifying an entity, each said database identification record comprising a plurality of data elements encoded with functional dependencies, each of said encoded data elements being further associated with a consensus value, and
at least one application programming interface, comprising at least one non-transitory processor-readable medium having stored thereon processor-executable code, said at least one application programming interface configured to:
a. receive, from a source, identification data comprising an incoming identification record identifying a second entity, comprising a plurality of data elements;
b. structure the incoming identification record so as to associate the data elements of the incoming identification record with a plurality of predetermined fields, wherein a first data element of the incoming identification record is associated with a first predetermined field and a second data element of the incoming identification record is associated with a second predetermined field, and to standardize each of the data elements associated with a predetermined field in accordance with standards designated for the predetermined field;
c. encode each data element of the incoming identification record associated with a predetermined field with one or more functional dependencies appropriate to the field;
d. compare the encoded data elements of the incoming identification record to the encoded data elements of the database identification records;
e. count the matches between the encoded data elements of the incoming identification record and each of the database identification records;
f. if the comparison does not determine that the incoming customer record identifies a customer identified in any of the at least two database customer record S, then
i. add as a new record in the at least one data validation server, the incoming identification record, and
ii. associate a consensus value, according to a predetermined weighting system, with each functionally dependent data element of the incoming identification record;
g. if the comparison determines that the incoming identification record and a database identification record identify the same entity, then
i. updating the consensus values associated with the encoded data elements of the “same entity” database identification record to reflect, according to a predetermined weighting system, the results of comparing the encoded data elements of the incoming identification record and the “same entity” database identification record; and
ii. associating at least one data element consensus value with the incoming identification record, each said data element consensus value comprising a value reflecting, according to a predetermined weighting system, the results of comparing the encoded data element of the incoming identification record and the encoded data element pertaining to the same field of the “same entity” database identification record;
h. storing the incoming identification record on the at least one data validation server.

3. A system for data integrity validation, comprising an enterprise community having a plurality of enterprise members, each controlling customer records comprising data pertaining to customers, and a computer system comprising an applications programming interface and a database, wherein:
a. the database comprises at least one non-transitory processor-readable medium configured to maintain data associated with at least one first customer, comprising a first customer record associated with the first customer, said first customer record comprising a plurality of first customer data elements, at least two of said data elements each having functional dependencies and consensus values associated therewith; and
b. the applications programming interface comprises at least one non-transitory processor-readable medium having stored thereon processor-executable code, programmed to receive from an enterprise member a second customer record associated with a second customer, comprising a plurality of second customer data elements and to:
i. associate each of the plurality of second customer data elements with a predetermined field;
ii. standardize each of said plurality of second customer data elements in accordance with standards designated for the predetermined field with which the data element is associated;
iii. associate at least two of the plurality of second customer data elements with functional dependencies appropriate to their respective predetermined fields;
iv. evaluate, based on the extent of matching of functionally dependent data elements in the second customer record as compared to functionally dependent data elements found in the customer records of the database, whether the second customer is likely to be the same entity as one of the at least one first customers;
v. if the second customer appears to be a different entity than any at least one first customer, then:
1. further associate with the at least two second customer data elements that are associated with functional dependencies, a consensus value; and
2. add the second customer record to the database as a new record;
vi. if the second customer appears to be the same entity as at least one first customer, then:
1. update the consensus values associated with the first customer data elements to reflect, according to a predetermined weighting system, the results of comparing those elements to the second customer data elements; and
2. store the second customer record.

4. The system of claim 3, wherein if the second customer appears to be the same entity as at least one first customer, the applications programming interface is further programmed to:
a. Compare the functionally dependent second customer data elements with the functionally dependent data elements of the at least one first customer that appears to be the same entity, and count the number of matching data elements identified by said comparison;
b. Calculate a consensus value for the second customer record as a whole according to a predetermined weighting system that comprises at least in part a count of matching functionally dependent customer data elements;

5. The system of claim 3, wherein if the second customer appears to be the same entity as at least one first customer, the applications programming interface is further programmed to
a. compare the functionally dependent second customer data elements with the functionally dependent data elements of the at least one first customer that appears to be the same entity, and count the number of matching data elements identified by said comparison;
b. calculate a consensus value for each functionally dependent field of the second customer data record according to a predetermined weighting system that comprises at least in part a count of the number of matching data elements identified by comparison of the functionally dependent second customer data elements with each customer record that appears to be associated with the same entity.

6. A method for data integrity validation in an enterprise community having a plurality of enterprise members each controlling records comprising data and having at least one data validation server comprising at least one non-transitory processor-readable medium, configured to maintain a set of data comprising at least two database records, each said database record comprising a plurality of data elements encoded with functional dependencies, each of said encoded data elements being further associated with a consensus value, the method comprising:
a. receiving from an enterprise member, at an application programming interface comprising at least one non-transitory processor-readable medium having stored thereon processor-executable code, an incoming record comprising a plurality of data elements;
b. accepting the incoming record and structuring the incoming record to associate the data elements of the incoming record with a plurality of predetermined fields, wherein a first data element of the incoming record is associated with a first predetermined field and a second data element of the incoming record is associated with a second predetermined field, and to standardize each of the data elements associated with a predetermined field in accordance with standards designated for the predetermined field;
c. encoding at least one of the data elements of the incoming record with one or more functional dependencies appropriate to the field associated with the element;
d. comparing the encoded data elements of the incoming record to the encoded data elements of the database records;
e. counting the matches between the encoded data elements of the incoming record and each of the database records;
f. evaluating, according to a predetermined weighting system based at least in part on the number of matches between the encoded data elements, whether there is a match between the incoming record and a database record;
g. if the comparison does not determine that there is a match between the incoming record and a record identified in any of the at least two database records, then
i. adding as a new record in the at least one data validation server the incoming record and
ii. associating a consensus value, according to a predetermined weighting system, with each encoded data element of the incoming record;
h. if the comparison determines that there is a match between the incoming record and a database record, then
iii. updating the consensus values associated with the encoded data elements of the matching database record to reflect, according to a predetermined weighting system, the results of comparing the encoded data elements of the incoming record and the matching database record; and
iv. associating at least one data element consensus value with the incoming record, each said data element consensus value comprising a value reflecting, according to a predetermined weighting system, the results of comparing the encoded data element of the incoming record and the encoded data element pertaining to the same field of the matching database record;
i. storing the incoming record on the at least one data validation server;
j. providing a report, said report comprising at least one of:
v. the data consensus value for an encoded data element of the incoming record;
vi. a consensus value based at least in part upon the count of the matches between the encoded data elements of the incoming record and each of the database records, and at least in part upon the data consensus value for an encoded data element of the incoming record; and
vii. a consensus value for the incoming record to reflect, according to a predetermined weighting system, the results of comparing a plurality of the encoded data elements contained in fields of the incoming record with the encoded data elements contained in counterpart fields of the matching database record.
